(19) United States
(12) Patent Application Publication
(10) Pub. No.: US 2021/0060486 A1
(43) Pub. Date: Mar. 4, 2021

(54) Facility For Producing Gaseous Biomethane By Purifying Biogas From Landfill Combining Membranes, Cryodistillation And Deoxo

(71) Applicant: WAGA ENERGY, Meylan (FR)

(72) Inventor: Guénaël Prince, Saint Egreve (FR)

(21) Appl. No.: 16/949,718

(22) Filed: Nov. 11, 2020

(51) Int. Cl. B01D 53/75; B01D 53/04; B01D 53/22; B01D 53/26; B01D 53/047; B01D 53/86; F25J 3/02

(52) U.S. Cl. CPC B01D 53/75; B01D 2257/104; B01D 53/229; B01D 53/261; B01D 53/047; B01D 53/8671; B01D 53/226; F25J 3/0266; B01D 2053/221; B01D 2257/504; B01D 2257/708; B01D 2257/80; B01D 2253/102; B01D 2257/304; B01D 53/0462

(57) ABSTRACT

A process and facility for producing gaseous methane by purifying biogas from landfill can include a VOC purification unit, at least one membrane, a CO₂ purification unit, a cryodistillation unit comprising a heat exchanger and a distillation column, a deoxo, and a dryer.

### BACKGROUND

Biogas is produced by the decomposition of organic matter: it is made of methane, CO2, and other impurities depending on the biogas source. It can be produced in digesters, fed with agricultural wastes for example, in Waste Water Treatment Plants (WWTP), or in landfills. Biogas can then be transformed into energy either in internal combustion engines coupled with an alternator, thus producing electricity. It can also be upgraded and transformed into Renewable Natural Gas (RNG), displacing volumes of fossil natural gas when injected into the Natural Gas (NG) pipelines. This second path of valorization is much more efficient on an energy basis, as it allows to recover more than 90% of the energy contained in the raw gas, compared to 35% in the case of electricity production (no heat valorization). RNG is more and more seen as an effective way to decarbonize transportation, and more generally to decarbonize all the use of NG.

### SUMMARY

In accordance with embodiments. a facility for producing gaseous biomethane by purifying biogas from landfill can include a a compression unit for compressing an initial gas flow of the biogas to be purified, a VOC purification unit arranged downstream of the compression unit to receive the compressed initial flow of the biogas and comprising at least one adsorber loaded with adsorbents capable of reversibly adsorbing VOCs to thereby produce a VOC-depleted gas flow; at least one membrane arranged downstream of the VOC purification unit to receive the VOC-depleted gas flow and subject the VOC-depleted gas flow to at least one membrane separation, a CO₂ purification unit arranged downstream of the membrane to receive a retentate from the membrane, wherein the CO₂ purification unit comprises at least one adsorber loaded with adsorbents capable of reversibly adsorbing the majority of remaining CO₂ from the retentate to produce a CO₂-depleted gas flow; a cryodistillation unit comprising a heat exchanger and a distillation column, arranged downstream of the CO₂ purification unit to receive the CO₂-depleted gas flow and subject the CO₂-depleted gas flow to a cryogenic separation to separate O₂ and N₂ from the CO₂-depleted gas flow and to produce a gas distillate. The facility can optionally include a grid compressor. The facility can also include a deoxo arranged downstream the cryodistillation unit to receive the gas distillate from the distillation column capable of converting the O₂ present in the gas distillate into CO₂ and H₂O to produce an O₂ depleted gas flow, and a dryer, f a TSA (Temperature Swing Adsorption) arranged downstream the deoxo to receive the O₂ depleted gas flow capable of removing H₂O from the O₂ depleted gas flow.

### BRIEF DESCRIPTION OF THE DRAWINGS

FIG. 1 is a schematic illustration of a facility in accordance with an embodiment of the disclosure.

### DETAILED DESCRIPTION

The most important sources of biogas are landfills, but the biogas produced is highly polluted: the methane must be separated from CO2, H2S, VOC, siloxanes, and air gases (oxygen and nitrogen) prior pipe injection. Wagabox® is a breakthrough technology to transform the raw landfill gas, into clean RNG: the said technology is depicted in the patent FR-B-3046086 (U.S. patent application US2019/0001263). This process and corresponding facility has multiple steps to remove the impurities:
Blower to suck the gas from the landfill and to feed the compressor
Active carbon (AC) filters for H2S (or any other available technology)
Drier to remove H2O
Compression
PSA (Pressure Swing Adsorption) for VOCs
Membranes for CO2: 1, 2 or 3 stages
PTSA (Pressure Temperature Swing Adsorption) for the remaining CO2 at membrane system outlet
Cryodistillation for air gases (N2 & O2) removal from CH4
Grid compression, as distillation occurs at low pressure.

Cryodistillation is the most efficient process to separate nitrogen & oxygen from methane, and this technology has been patented by the applicant as well (FR-B-3051892).

Depending on the countries, or on the states in the case of USA, the gas grid specifications, which specify the quality the RNG shall comply, differ. This is particularly true when it comes to oxygen content in the RNG: depending on the grid owners, it can vary from 1% vol (10,000 ppmv) down to 10 ppmv.

This is a major technical challenge, even for best-in-class technologies like the Wagabox®. A target of 1,000 ppmv of O2 in the RNG can easily be reached with the Wagabox®, but lower oxygen specification would require excessive work from the distillation, leading to excessive loss of methane from the process.

In this case, the solution consists in adding a deoxo and a TSA that will remove oxygen from the RNG, downstream the cold box. In a deoxo, oxygen is converted into CO2 and H2O, by a classical combustion with the methane:

CH4+2.O2→CO2+2.H2O

This reaction is generally made on a catalyst, in order to lower the reaction temperature. Then, the moisture (H2O) can easily be removed with a TSA (Temperature Swing Adsorption). In the TSA, water is removed on a dedicated adsorbent in a bottle, while the other bottle is heat regenerated.

There are multiple benefits in coupling a deoxo and a TSA with a Wagabox®, in case of very stringent specifications:
The cryogenic distillation is removing all the remaining impurities from the landfill gas that will not have been trapped by the upstream process, with a cryogenic filter on the RNG: this is particularly important to protect the deoxo catalyst, which is very sensitive to pollution.
Oxygen can be removed in different location of the process: in the 1st stage of the membranes (the effect of O2 removal with membranes in landfill gas upgrading is well-known), in the distillation, and eventually in the deoxo. An important amount of O2 in the deoxo can be critical as the reaction temperatures could rise well above the thermal calculation of the catalyst, due to the highly exothermic oxidation reaction between O2 and CH4.
There is no need to remove the CO2 produced in the deoxo, as the heating of the RNG produced in the distillation column is high enough to cope with most of the gas grid specifications. In particular, nitrogen can easily be adjusted in the distillation column, to compensate any excess of CO2 produced in the deoxo.

There are few locations for the deoxo and TSA dryer:

Solution 1: in between the membrane unit and the PTSA unit. In this arrangement, CO2 is removed in the PTSA prior the cold box. The flow treated is more important as it contains the vent gas of the distillation (and not only the RNG), and deoxo may have to face with impurities at membrane outlet.

Solution 2: downstream distillation, but upstream grid gas compressor: the deoxo and TSA operates at low pressure. The RNG is very clean and contains no oil at all, so no risk of polluting the deoxo.

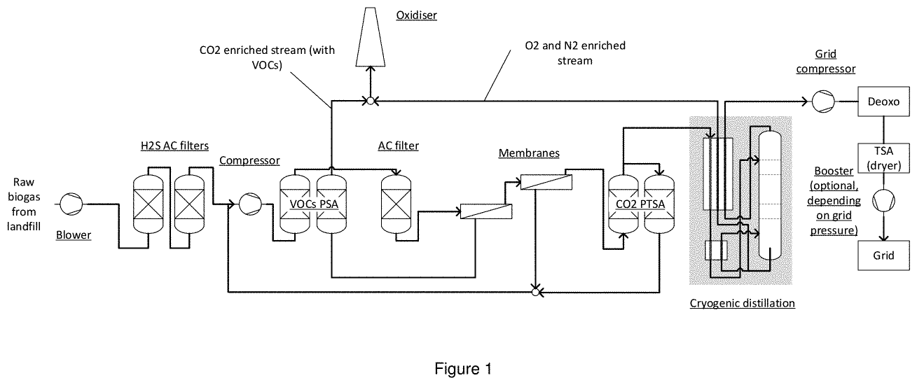

Solution 3: downstream grid compressor (as featured in the FIG. 1): deoxo and TSA operate under pressure, which can reduce their size, and increase their efficiency. If necessary, a booster can be added downstream the TSA, in case the optimum operating pressure of the deoxo and the TSA is lower than the grid pressure.

In accordance with embodiments. a facility for producing gaseous biomethane by purifying biogas from landfill can include a compression unit for compressing an initial gas flow of the biogas to be purified, a VOC purification unit arranged downstream of the compression unit to receive the compressed initial flow of the biogas and comprising at least one adsorber loaded with adsorbents capable of reversibly adsorbing VOCs to thereby produce a VOC-depleted gas flow; at least one membrane arranged downstream of the VOC purification unit to receive the VOC-depleted gas flow and subject the VOC-depleted gas flow to at least one membrane separation, a CO₂ purification unit arranged downstream of the membrane to receive a retentate from the membrane, wherein the CO₂ purification unit comprises at least one adsorber loaded with adsorbents capable of reversibly adsorbing the majority of remaining CO₂ from the retentate to produce a CO₂-depleted gas flow; a cryodistillation unit comprising a heat exchanger and a distillation column, arranged downstream of the CO₂ purification unit to receive the CO₂-depleted gas flow and subject the CO₂-depleted gas flow to a cryogenic separation to separate O₂ and N₂ from the CO₂-depleted gas flow and to produce a gas distillate. The facility can optionally include a grid compressor. The facility can also include a deoxo arranged downstream the cryodistillation unit to receive the gas distillate from the distillation column capable of converting the O₂ present in the gas distillate into CO₂ and H₂O to produce an O₂ depleted gas flow, and a dryer, f a TSA (Temperature Swing Adsorption) arranged downstream the deoxo to receive the O₂ depleted gas flow capable of removing H₂O from the O₂ depleted gas flow.

What is claimed:

1. A facility for producing gaseous biomethane by purifying biogas from landfill, comprising:
a compression unit for compressing an initial gas flow of the biogas to be purified,
a VOC purification unit arranged downstream of the compression unit to receive the compressed initial flow of the biogas and comprising at least one adsorber loaded with adsorbents capable of reversibly adsorbing VOCs to thereby produce a VOC-depleted gas flow;
at least one membrane arranged downstream of the VOC purification unit to receive the VOC-depleted gas flow and subject the VOC-depleted gas flow to at least one membrane separation,
a CO₂ purification unit arranged downstream of the membrane to receive a retentate from the membrane, wherein the CO₂ purification unit comprises at least one adsorber loaded with adsorbents capable of reversibly adsorbing the majority of remaining CO₂ from the retentate to produce a CO₂-depleted gas flow;
a cryodistillation unit comprising a heat exchanger and a distillation column, arranged downstream of the CO₂ purification unit to receive the CO₂-depleted gas flow and subject the CO₂-depleted gas flow to a cryogenic separation to separate O₂ and N₂ from the CO₂-depleted gas flow and to produce a gas distillate,
optionally a grid compressor,
a deoxo arranged downstream the cryodistillation unit to receive the gas distillate from the distillation column capable of converting the O₂ present in the gas distillate into CO₂ and H₂O to produce an O₂ depleted gas flow,
a dryer, especially a TSA (Temperature Swing Adsorption) arranged downstream the deoxo to receive the O₂ depleted gas flow capable of removing H₂O from the O₂ depleted gas flow.
